(19) United States
(12) Patent Application Publication
(10) Pub. No.: US 2005/0017022 A1
(43) Pub. Date: Jan. 27, 2005

(54) Bottle cap puncturing device

(76) Inventor: Aaron Faygenov, Brea, CA (US)

Correspondence Address: Aaron Faygenov, 303 Calico CT., Brea, CA, 92821, US

(21) Appl. No.: 10/626,279

(22) Filed: Jul. 24, 2003

(51) Int. Cl. B67D 5/00

(52) U.S. Cl. 222/83.5; 222/185.1

(57) ABSTRACT

An article intended to be attached to or built as an integral part of a water cooler that uses water bottles. This article has a long spear shaped part with a sharp tip in a vertical position. This article allows placing a water bottle on the water cooler while its cap is still on the bottle neck. When the bottle is placed on the water cooler, the sharp tip punctures the water bottle's cap allowing water to flow into the cooler. The benefit of the invention of this application is that it prevents any water from splattering on and around the water cooler, when placing the bottle on the cooler, as a result of inverting the water bottle into the cooler with its cap removed off its bottle neck.

### BACK GROUND FIELD OF INVENTION

The invention of this application relates to water coolers into which water bottles are placed with their neck and opening facing down. The invention of this application offers a device that can be manufactured as a part of the water cooler or as an independent part that can be placed on the water cooler. Water bottles intended to be used with water coolers are usually supplied full with water and caped with a plastic cap. The invention of this application offers a device with a vertical spear head shaped part placed in a water cooler that punctures the cap on the bottle when the bottle is placed neck down on the water cooler, allowing water to flow into the water cooler.

### BACK GROUND OF PRIOR ART

The inventor of this application could not find any device that is intended to puncture a standard water bottle cap for water coolers.

### OBJECTS AND ADVANTAGES

Currently, when placing a water bottle on a water cooler, the consumer has to remove the plastic cap off the bottle, invert the bottle with the neck facing down, and place the bottle on the water cooler. In the process, due to the inversion of the bottle without the cap, water splatters all over and around the water cooler. This is a major inconvenience. The object of this invention is to offer a device that allows the consumer to place a water bottle on a water cooler without having to remove the cap off its neck. When a bottle is placed on the water cooler, the cap puncturing device of this application punctures the bottle's cap, and allows water to flow into the water cooler. The advantage of the invention of this application is that it allows placing a bottle on a water cooler without any water splattering on the cooler and the area around it. The device of this application can be built as an integral part of a water cooler or as an independent article that can be easily attached to a water cooler. It is inexpensive to manufacture, very easy to install, and easy to use.

### DRAWING FIGURES

FIG. 1 shows the first preferred embodiment of the bottle cap puncturing device of this application.

FIG. 2 shrews the second preferred embodiment of the bottle cap puncturing device of this application.

### REFERENCE NUMERALS N DRAWINGS

10 rim
20 arch
30 pin
40 base
50 hole
60 adhesive tape

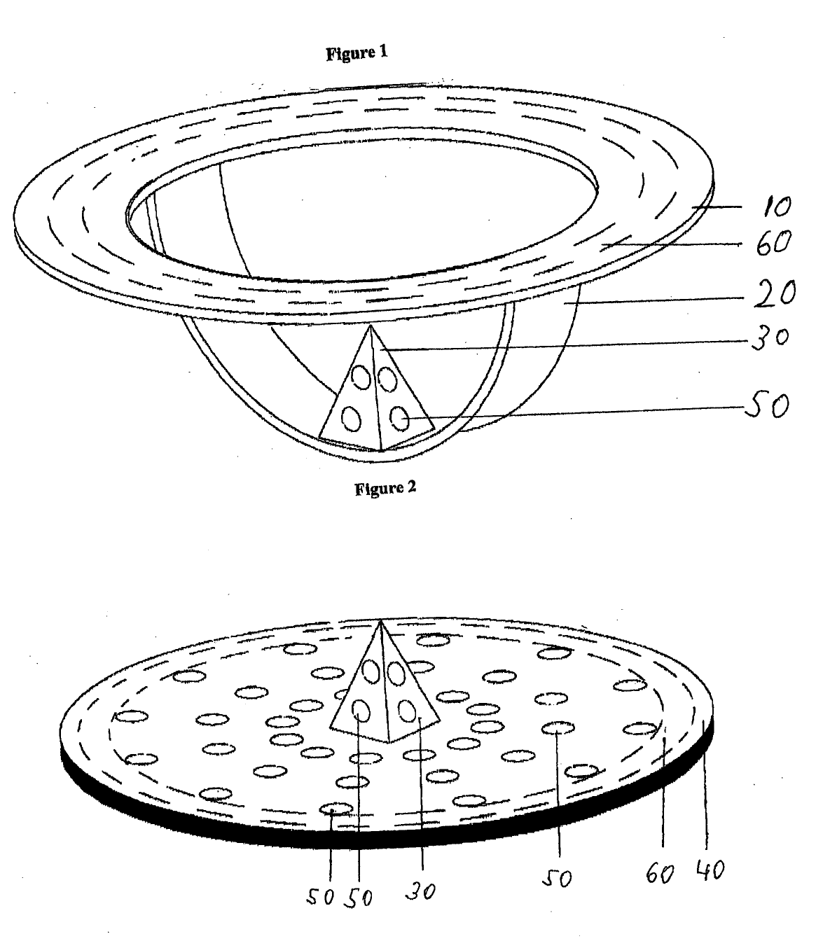

### DESCRIPTION FIGS. 1 AND 2

FIG. 1 shows a three dimensional drawing of the first preferred embodiment of the bottle cap puncturing device of this application.

FIG. 2 shows a three dimensional drawing of the second preferred embodiment of the bottle cap puncturing device of this application.

Operation FIGS. 1 and 2

FIG. 1: Rim (10) is placed on the edge of the water cooler's bottle receptacle hole using adhesive tape (60) to attach rim (10) to the edge. Arch (20) is suspended in the bottle receptacle hole with the pin (30) standing vertically. When a water bottle with its cap called is placed neck facing down into the water cooler's bottle receptacle hole, pin (30) pictures the cap, and water flows into the water cooler.

FIG. 2: Base (40) is placed and attached to the base of a water cooler's bottle receptacle hole by adhesive tape (60) with pin (30) standing vertically. When a water bottle with its cap caped is placed neck facing down into the water cooler's bottle receptacle hole, pin (30) punctures the cap, and water flows into the water cooler through holes (50).

Summery, Ramifications, and Scope

Accordingly, the bottle cap puncturing device of this application offers an article that can be placed on a water cooler of the type that uses water bottles. Then, a water bottle can be placed into the water cooler's bottle receptacle hole without having to remove the cap off the bottle, and the bottle cap puncturing device of this application will puncture the cap allowing water to enter the water cooler.

The reader can see that the bottle cap puncturing device of this application offers great benefits bad allowing the placement of a bottle on a cooler with great ease as well as by preventing water from splattering on and around the water cooler, when placing a bottle on the water cooler with its cap removed as is currently done.

The drawings show two of the preferred embodiments of the bottle cap puncturing device of this application, but it is not limited to those embodiments. The pin can be of many shapes that are sharp enough to puncture a bottle's cap. The whole bottle cap puncturing device of this application can be manufactured as an independent device, and attached to a water cooler by any means of attachment or it can be manufactured as an integral part of the water cooler it self.

Thus, the scope of this invention should be determined by the appended claims and their legal equivalents rather than by the examples given.

1. A device, consisting:
(a) a base
(b) an elongated article with a sharp tip.
(c) means for attaching said device to a water cooler.

2. Said elongated article with a sharp tip of claim 1 is sharp enough to puncture a bottle's cap.

3. Said elongated article with a sharp tip of claim 1 is of sufficient length allowing the puncturing of a bottle's cap.

4. Said elongated article with a sharp tip of claim 1 is of sufficient strength to hold the weight and pressure of a bottle fill with water placed on said device of claim 1.

5. Said device of claim 1 is an independent structure.

6. Said device of claim 1 is an integral structure of a water cooler.
